(19) United States
(12) Patent Application Publication
(10) Pub. No.: US 2017/0129305 A1
(43) Pub. Date: May 11, 2017

(54) IN-CAR SOLAR-POWERED HEAT DISSIPATER CAPABLE OF DISCHARGING TOXIC SUBSTANCES AND DOUBLING AS MULTIFUNCTIONAL BACKUP POWER SUPPLY

(71) Applicant: YUNG-YU WU, TAOYUAN CITY (TW)

(72) Inventor: YUNG-YU WU, TAOYUAN CITY (TW)

(21) Appl. No.: 14/933,488

(22) Filed: Nov. 5, 2015

(51) Int. Cl. B60H 1/00; H02S 10/40; B60H 1/24

(52) U.S. Cl. CPC B60H 1/00264; B60H 1/00428; B60H 1/243; B60H 1/248; B60H 1/00828; H02S 10/40

(57) ABSTRACT

An in-car solar-powered heat dissipater capable of discharging toxic substances and doubling as a multifunctional backup power supply is to be mounted at the upper edge of the glass pane of a window of a car and includes a housing, at least one wind-generating unit, a solar cell panel, an activating/deactivating means, an output connection port, and an input connection port. The housing has an air channel in communication with the interior space and the exterior space of the car. The air channel is provided with a cover for closing and opening the air channel. The wind-generating unit can be activated and deactivated by operating the cover. The output connection port and the input connection port can be used to output and input electricity respectively.

### BACKGROUND OF THE INVENTION

1. Technical Field

The present invention relates to heat dissipaters and more particularly to an in-car solar-powered heat dissipater to be mounted at the upper edge of the glass pane of a car window in order to draw air out of the car and/or serve as a multifunctional backup power supply.

2. Description of Related Art

On a hot summer day, the temperature inside a car parked outdoors tends to rise rapidly due to direct exposure to the sun. If the driver leaves the car in direct sunlight for some time, he or she will feel an unbearable heat when re-entering the car. In that case, it is common practice for the driver to open all the car doors or windows to allow air circulation through the car. Or the driver can turn on the air conditioner of the car, make it operate in the cooling or fan mode, then get out of the car, waiting, and get back into the car only when the temperature in the car has lowered. The foregoing process, however, is neither economical nor environmentally friendly, simply considering the fact that energy sources are at a premium nowadays.

If the car is exposed to sunlight for an extended amount of time, the seats and the car interior may further emit toxic substances because of the high heat, which substances include formaldehyde, toluene, chlorinated paraffins, polybrominated biphenyl, and phenyl ether, to name only a few. Chlorinated paraffins, in particular, are solid mixtures of chlorinated alkanes and have been classified by the International Agency for Research on Cancer as group-2B carcinogens, with the risks of causing sterility, the metabolic syndrome, autoimmune diseases, and so on.

Even if the driver turns on the air conditioner immediately after he or she gets into the car, the toxic substances would keep circulating in the closed interior space of the car without being discharged, despite the rapid cooling effect achieved.

To solve the aforementioned problems, a solar-powered heat-dissipating device for use on a car window has been developed as disclosed in Taiwan Patent No. M435998. The solar-powered heat-dissipating device for use on a car window is provided with a straddling base, two wind-generating units, and a solar cell panel. The straddling base is configured to straddle on the upper edge of the glass pane of a car window. Inside the straddling base are two separated air channels which are respectively in communication with the interior space and the exterior space of the car. The two wind-generating units are provided in the two air channels respectively.

Such a solar-powered heat dissipater is typically mounted in the gap between a car window and the car window frame and is exposed to sunlight in order to convert solar energy into electrical energy. The electrical energy is then used to rotate fans so that the hot air in the car can be drawn out through an air outlet. When the car's air conditioner is turned on, however, the fans must be turned off, otherwise the cool air in the car would be discharged. In addition, the air outlet must be covered with an object to prevent the cool air from escaping. An alternative way is to remove the solar-powered heat dissipater from the car window, which is nevertheless inconvenient.

In light of the above, it has been a goal for the inventor of the present invention and those in the industry to overcome the foregoing problems and drawbacks of the prior art.

### BRIEF SUMMARY OF THE INVENTION

To overcome the problems and drawbacks mentioned above, the inventor of the present invention not only gathered related information for comprehensive evaluation and consideration, but also put years of practical experience in the industry into repeated trials and modifications. Finally, the design of the present invention was completed as disclosed herein.

It is an objective of the present invention to provide an in-car solar-powered heat dissipater capable of discharging toxic substances and doubling as a multifunctional backup power, wherein the heat dissipater has a wind-generating unit which can be activated and deactivated by operating a cover.

Another objective of the present invention is to provide an in-car solar-powered heat dissipater capable of discharging toxic substances and doubling as a multifunctional backup power, wherein the heat dissipator has an output connection port and an input connection port in order to output and input electricity respectively.

To achieve the above and other objectives, the present invention provides an in-car solar-powered heat dissipater capable of discharging toxic substances and doubling as a multifunctional backup power, wherein the heat dissipator is configured to be mounted at the upper edge of the glass pane of a window of a car and includes a housing, at least one wind-generating unit, a solar cell panel, an activating/deactivating means, an output connection port, and an input connection port. The housing is configured to be mounted at the upper edge of the glass pane of the window of the car and has an air channel in communication with the interior space and the exterior space of the car, wherein the air channel is provided with a cover for closing and opening the air channel. The wind-generating unit is provided in the air channel and is configured to draw the air in the interior space of the car to the exterior space of the car. The solar cell panel is provided on the housing and is to be located in the exterior space of the car. The solar cell panel is electrically connected to the wind-generating unit in order to supply electricity to the wind-generating unit. The activating/deactivating means is connected between the wind-generating unit and the solar cell panel in order to stop electricity supply to the wind-generating unit when the cover closes the air channel and to allow electricity supply to the wind-generating unit when the cover opens the air channel. The output connection port is electrically connected to the solar cell panel and is configured to output the electricity generated by the solar cell panel. The input connection port is electrically connected to the wind-generating unit and is configured to input electricity to be supplied to the wind-generating unit.

In a preferred embodiment, the solar cell panel is provided at the housing through a pivot shaft.

In a preferred embodiment, the output connection port is configured to output direct-current electricity.

In a preferred embodiment, the input connection port is configured to input direct-current electricity.

According to the present invention, the cover of the air channel can be used to activate and deactivate the wind-generating unit, and the output connection port and the input connection port can be used to output and input electricity respectively.

### BRIEF DESCRIPTION OF THE SEVERAL VIEWS OF THE DRAWINGS

FIG. 1 is an exploded perspective view of the in-car solar-powered heat dissipater in a preferred embodiment of the present invention, which is capable of discharging toxic substances and doubling as a multifunctional backup power supply;

FIG. 2 is another exploded perspective view of the in-car solar-powered heat dissipater in FIG. 1;

FIG. 3 schematically shows how the in-car solar-powered heat dissipater in FIG. 1 is used; and

FIG. 4 is a perspective view showing how the in-car solar-powered heat dissipater in FIG. 1 is used.

### DETAILED DESCRIPTION OF THE INVENTION

The technical means and structures adopted by the present invention to achieve the aforesaid objectives and effects can be fully understood by referring to the detailed description of the features and functions of a preferred embodiment of the invention.

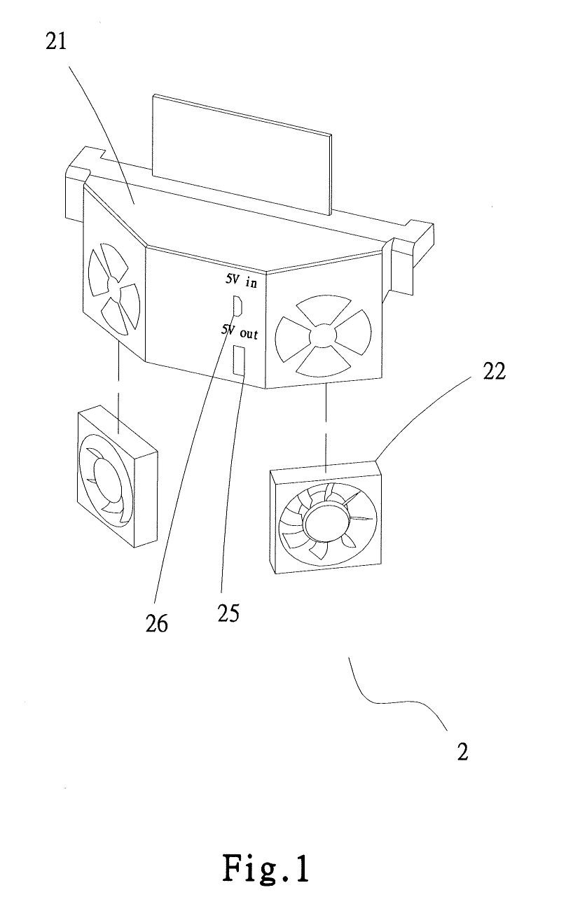

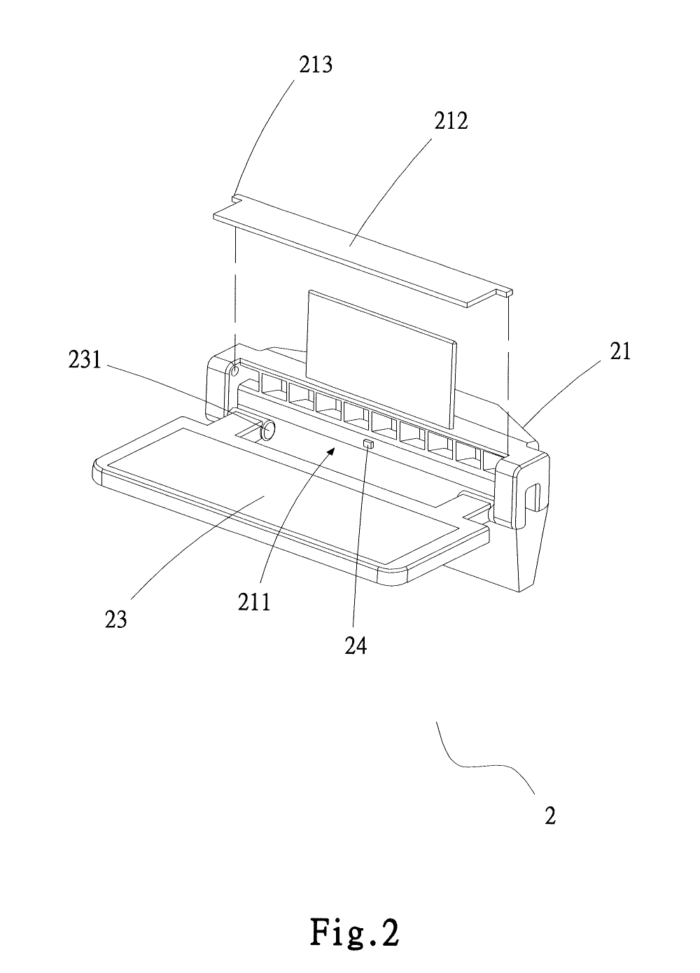

As shown in FIGS. 1, 2, and 3, the in-car solar-powered heat dissipater 2 capable of discharging toxic substances and doubling as a multifunctional backup power supply is configured to be mounted at the upper edge of the glass pane 11 of a window of a car 1, that is to say, to be mounted in the space between the upper edge of the glass pane 11 and the corresponding window frame of the car 1. The heat dissipater 2 includes a housing 21, at least one wind-generating unit 22, a solar cell panel 23, an activating/deactivating means 24, an output connection port 25, and an input connection port 26.

The housing 21 is configured to be mounted at (e.g., installed at and fixed to) the upper edge of the glass pane 11 of the window of the car 1. The housing 21 has an air channel 211 in communication with the interior space and the exterior space of the car 1. A plurality of channel baffles can be provided in the air channel 211 to guide airflow into the desired directions. In addition, the air channel 211 has a cover 212 for closing and opening the air channel 211. The cover 212 can be pivotally connected to the air channel 211 by a pivot shaft 213. The pivot shaft 213 allows the cover 212 to be angularly displaced and thereby close or open the air channel 211.

The at least one wind-generating unit 22 is provided in the air channel 211 and can be a fan for example. The number of the at least one wind-generating unit 22 may vary according to practical needs and is illustrated in this embodiment as two by way example. The wind-generating units 22 are configured to draw the air in the interior space of the car 1 to the exterior space of the car 1.

The solar cell panel 23 is provided on the housing 21 and should be placed in the exterior space of the car 1. The solar cell panel 23 is provided at the housing 21 via a pivot shaft 231, which allows the solar cell panel 23 to be angularly displaced and thereby adjusted to the optimal angle for receiving light. The solar cell panel 23 is electrically connected to the wind-generating units 22 in order to supply electricity to the wind-generating units 22.

The activating/deactivating means 24 is connected between the wind-generating units 22 and the solar cell panel 23. When the cover 212 closes the air channel 211, the activating/deactivating means 24 cuts off electricity supply to the wind-generating units 22. When the cover 212 opens the air channel 211, the activating/deactivating means 24 allows electricity to be supplied to the wind-generating units 22. That is to say, the wind-generating units 22 can be stopped by closing the cover 212 (and hence the air channel 211) and be brought into operation by opening the cover 212 (and hence the air channel 211).

The output connection port 25 is electrically connected to the solar cell panel 23 to output the electricity generated by the solar cell panel 23. Moreover, the output connection port 25 is configured to output direct-current electricity.

The input connection port 26 is electrically connected to the wind-generating units 22 to input electricity for use by the wind-generating units 22. The input connection port 26 is configured to input direct-current electricity.

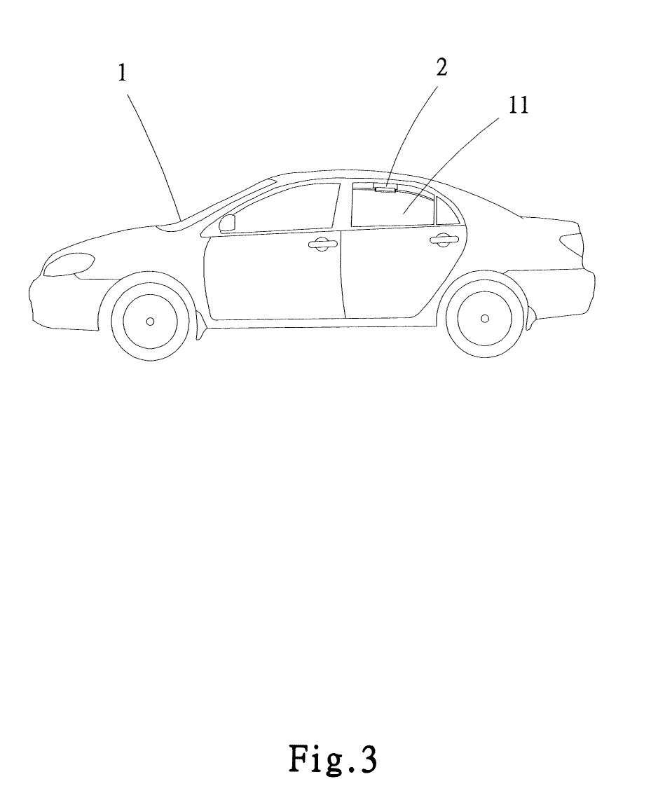

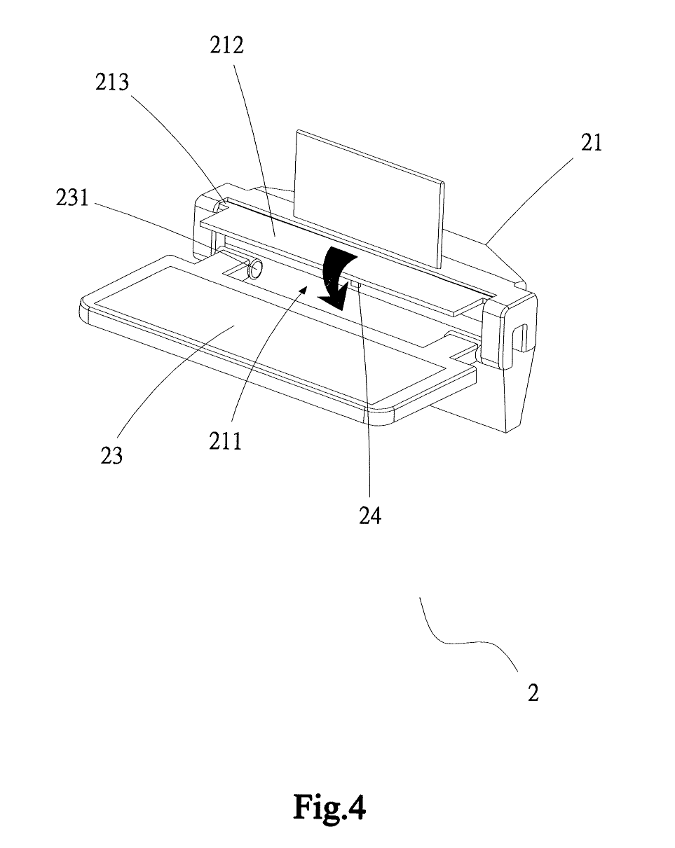

Based on the structures and design described above, the heat dissipater 2 of the present invention is used and operates as follows, with reference to FIGS. 3 and 4. To apply the heat dissipater 2 to the car 1, the heat dissipater is mounted at the upper edge of the glass pane 11 of a window of the car. More specifically, the glass pane of the window is lowered by an appropriate distance to create a gap between the glass pane and the window frame, and the heat dissipator 2 is mounted in the gap.

Once the heat dissipater 2 is installed, the cover 212 is adjusted to open the air channel 211, and the solar cell panel 23 is adjusted to a proper angle for optimal light reception. After the adjustments, the solar cell panel 23 can supply electricity to the wind-generating units 22 to bring the wind-generating units 22 into operation, thereby drawing the air in the interior space of the car 1 to the exterior space of the car 1 through the air channel 211. The heat dissipater 2 thus removes hot air from inside the car 1.

When the car 1 is running, with the air conditioner turned on, it is no more necessary to extract air from inside the car for heat dissipation, so the cover 212 should be adjusted to close the air channel 211. As the cover 212 closes the air channel 211, the activating/deactivating means 24 stops electricity supply to the wind-generating units 22. Consequently, the wind-generating units 22 stop operation, and the interior space of the car is allowed to cool because the cool air in the car will neither be drawn out by the wind-generating units 22 nor escape through the air channel 211, which is now closed by the cover 212.

Moreover, the output connection port 25 and the input connection port 26 of the heat dissipater 2 can respectively output the electricity generated by the solar cell panel 23 and input electricity to the wind-generating units 22. A mobile power supply, for example, can be connected through a cable to the output connection port 25 in order to be charged with the electricity generated by the solar cell panel 23. On the other hand, a mobile power supply of an adequate level of electricity can be connected through a cable to the input connection port 26 in order to supply the electricity in the mobile power supply to the wind-generating units 22.

Thus, the heat dissipater 2 of the present invention can be used to charge an electronic product by outputting through the output connection port 25 the electricity generated by the solar cell panel 23. The heat dissipater 2 can also be connected with an external power supply to power the wind-generating units 22.

In other words, when a car equipped with the heat dissipater 2 is running and does not need heat dissipation or a discharge of toxic substances, the electrical energy produced by the solar cell panel 23 can be used to charge a handheld electronic product such as a smart phone, tablet computer, etc., thereby eliminating the need to use a mobile power supply or draw electricity from the car at the expense of the gasoline in the car. In doing so, the present invention makes effective use of solar power while achieving the unanticipated effects of saving energy and reducing carbon dioxide emissions.

Referring to FIGS. 1 through 4, the present invention has the following advantages over the prior art: First, the wind-generating units 22 of the heat dissipater 2 can be activated and deactivated by operating the cover 212. Second, the output connection port 25 and the input connection port 26 of the present invention can be used to output and input electricity respectively.

Please note that the foregoing embodiment is only a preferred one of the present invention and is not restrictive of the scope of the invention. All simple modifications and equivalent changes made according to this specification and the accompanying drawings should fall within the scope of the invention.

What is claimed is:

1. An in-car solar-powered heat dissipater capable of discharging toxic substances and doubling as a multifunctional backup power supply, to be mounted at an upper edge of a glass pane of a window of a car, the heat dissipater comprising:
a housing to be mounted at the upper edge of the glass pane of the window of the car, the housing having an air channel in communication with an interior space and an exterior space of the car, the air channel being provided with a cover for closing and opening the air channel;
at least one wind-generating unit provided in the air channel and configured to draw air in the interior space of the car to the exterior space of the car;
a solar cell panel provided on the housing and to be located in the exterior space of the car, the solar cell panel being electrically connected to the wind-generating unit in order to supply electricity to the wind-generating unit;
an activating/deactivating means connected between the wind-generating unit and the solar cell panel in order to stop electricity supply to the wind-generating unit when the cover closes the air channel and to allow electricity supply to the wind-generating unit when the cover opens the air channel;
an output connection port electrically connected to the solar cell panel and configured to output electricity generated by the solar cell panel; and
an input connection port electrically connected to the wind-generating unit and configured to input electricity to be supplied to the wind-generating unit.

2. The heat dissipater of claim 1, wherein the cover is provided at the air channel through a pivot shaft.

3. The heat dissipater of claim 1, wherein the solar cell panel is provided at the housing through a pivot shaft.

4. The heat dissipater of claim 1, wherein the output connection port is configured to output direct-current electricity.

5. The heat dissipater of claim 1, wherein the input connection port is configured to input direct-current electricity.
